(19) United States
(12) Patent Application Publication
(10) Pub. No.: US 2026/0078729 A1
(43) Pub. Date: Mar. 19, 2026

(54) SYSTEMS AND METHODS FOR SELECTIVELY ENABLING REGENERATION OF AN EXHAUST AFTERTREATMENT SYSTEM COMPONENT

(71) Applicant: Cummins Inc., Columbus, IN (US)

(72) Inventors: Sanjaya Kumar Behera, Jajpur (IN); Vishal Randev, Pune (IN); Ashish D. Shirure, Latur (IN); Neha Deshmukh, Madhya (IN); Arundhatti Bezbaruah, Jorhat (IN); Gobala M. Krishan, Tamilnadu (IN)

(73) Assignee: Cummins Inc., Columbus, IN (US)

(21) Appl. No.: 19/332,912

(22) Filed: Sep. 18, 2025

(30) Foreign Application Priority Data
Sep. 19, 2024 (IN) 202441070857

(51) Int. Cl. F02N 9/00

(52) U.S. Cl. CPC F02N 9/00; F01N 2900/08; F01N 2900/10; F01N 2900/1404

(57) ABSTRACT

A system includes a controller coupled to an aftertreatment system. The controller is configured to identify a request for a regeneration process associated with a component of the aftertreatment system based on receiving an input at an operator input device or receiving, from a sensor, data regarding the aftertreatment system. The controller is configured to receive, from a memory device, a latch status. The controller is configured to receive, from the memory device, a time value responsive to the latch status being a first latch status. The controller is configured to modify the latch status to a second latch status responsive to the time value being at or above a threshold such that the regeneration process is enabled. The controller is configured to prevent the regeneration process responsive to the time value being below the threshold.

### CROSS-REFERENCE TO RELATED-APPLICATION

This U.S. patent application claims the benefit and priority to Indian Application No. 202441070857, filed Sep. 19, 2024, the entire disclosures of which is hereby incorporated by reference herein.

### TECHNICAL FIELD

The present disclosure relates to selectively enabling regeneration of an exhaust aftertreatment system component.

### BACKGROUND

Many engines are coupled to exhaust aftertreatment systems that reduce harmful exhaust gas emissions (e.g., nitrous oxides (NOx), sulfur oxides, particulate matter, etc.). A component of the exhaust aftertreatment system, such as a particulate filter, may require regeneration to remove deposits, such as particulate matter, from the component. Regeneration of the component may require a change in operation of the engine, the aftertreatment system, or both.

### SUMMARY

One embodiment relates to a system. The system includes a controller coupled to an aftertreatment system in exhaust gas receiving communication with an engine. The controller includes at least one processor and at least one memory device storing instructions therein that, when executed by the at least one processor, cause the controller to perform operations. The operations include: identifying a request for a regeneration process associated with a component of the aftertreatment system based on at least one of receiving an input at an operator input device or receiving, from one or more sensors, operating data regarding the aftertreatment system; receiving, from the at least one memory device, a latch status associated with an operator interface device, the latch status including one of a first latch status or a second latch status; receiving, from the at least one memory device, a time value associated with a user input responsive to the latch status being the first latch status; modifying the latch status to the second latch status responsive to the time value being at or above a predetermined threshold such that the regeneration process is enabled responsive to receiving the request for the regeneration process; preventing the regeneration process responsive to the time value being below the predetermined threshold; and setting the time value to a predetermined value responsive to the latch status being the second latch status.

In some embodiments, the user input is a first user input. In some embodiments, receiving the latch status associated with the operator interface device is responsive to: receiving the first user input at the operator interface device; and receiving, from the operator interface device, a first signal indicating that the latch status is the first latch status responsive to receiving the first user input at the operator interface device.

In some embodiments, setting the time value to the predetermined value responsive to the latch status being the second latch status is responsive to: receiving a second user input at the operator interface device, subsequent to receiving the first user input and prior to the time value being at or above the predetermined threshold; and receiving, from the operator interface device, a second signal indicating that the latch status is the second latch status responsive to receiving the second user input at the operator interface device.

In some embodiments, the instructions, when executed by the at least one processor, cause the controller to perform further operations including: determining a power status associated with the engine based on receiving information indicative of the power status from at least one sensor associated with the engine, the power status including one of a first power status or a second power status; receiving, from the at least one memory device, the latch status responsive to the power status being the first power status; and modifying the latch status to the second latch status responsive to the power status being the second power status.

In some embodiments, the instructions, when executed by the at least one processor, cause the controller to perform further operations including setting the time value to the predetermined value responsive to the power status changing from the first power status to the second power status.

In some embodiments, the instructions, when executed by the at least one processor, cause the controller to perform further operations including: receiving, from the one or more sensors, an operating value regarding an operating condition of at least one of the aftertreatment system or the engine, responsive to the latch status being the second latch status; implementing the regeneration process responsive to the operating value being at or above the predetermined threshold; and preventing the regeneration process responsive to the operating value being below the predetermined threshold.

In some embodiments, the time value is an amount of time between a current time value and a previous time value corresponding to the user input. In some embodiments, the predetermined threshold is a calibratable value. In some embodiments, the regeneration process is an active regeneration process. In some embodiments, the predetermined value is zero.

Another embodiment relates to a method. The method includes: a identifying a request for a regeneration process based on at least one of receiving an input at an operator interface device or receiving, from one or more sensors, operating data regarding the aftertreatment system; receiving, from the at least one memory device, a latch status associated with an operator interface device, the latch status including one of a first latch status or a second latch status; receiving, from the at least one memory device, a time value associated with a user input responsive to the latch status being the first latch status; modifying the latch status to the second latch status responsive to the time value being at or above a predetermined threshold such that the regeneration process is enabled responsive to receiving the request for the regeneration process; preventing the regeneration process responsive to the time value being below the predetermined threshold; and setting the time value to a predetermined value responsive to the latch status being the second latch status.

In some embodiments, the user input is a first user input. In some embodiments, the method also includes: receiving the first user input at the operator interface device; and receiving, from the operator interface device, a first signal indicating that the latch status is the first latch status responsive to receiving the first user input at the operator interface device, wherein receiving the latch status is based on receiving the first signal.

In some embodiments, the method also includes: receiving a second user input at the operator interface device, subsequent to receiving the first user input and prior to the time value being at or above the predetermined threshold; and receiving, from the operator interface device, a second signal indicating that the latch status is the second latch status responsive to receiving the second user input at the operator interface device, wherein setting the time value to the predetermined value is responsive receiving the second signal.

In some embodiments, the method also includes determining a power status associated with an the engine based on receiving information indicative of the power status from at least one sensor associated with the engine, the power status including one of a first power status or a second power status; receiving, from the at least one memory device, the latch status responsive to the power status being the first power status; and modifying the latch status to the second latch status responsive to the power status being the second power status. In some embodiments, the method also includes setting the time value to the predetermined value responsive to the power status changing from the first power status to the second power status. In some embodiments, the method also includes receiving, from the one or more sensors, an operating value regarding an operating condition of at least one of an aftertreatment system or an engine coupled to the aftertreatment system, responsive to the latch status being the second latch status; implementing the regeneration process responsive to the operating value being at or above the predetermined threshold; and preventing the regeneration process responsive to the operating value being below the predetermined threshold. In some embodiments, the operating value includes at least one of: a component temperature value regarding a component of the aftertreatment system, an exhaust gas temperature value regarding an exhaust gas emitted by the engine, or a speed value regarding a speed of the engine.

Still another embodiment relates to an apparatus. The apparatus includes at least one processor and at least one memory device storing instructions therein that, when executed by the at least one processor, cause the at least one processor to perform operations. The operations include: identifying a request for a regeneration process based on at least one of receiving an input at an operator input device or receiving, from one or more sensors, operating data regarding the aftertreatment system; receiving, from the at least one memory device, a latch status associated with an operator interface device, the latch status including one of a first latch status or a second latch status; receiving, from the at least one memory device, a time value associated with a user input responsive to the latch status being the first latch status; modifying the latch status to the second latch status responsive to the time value being at or above a predetermined threshold such that the regeneration process is enabled responsive to receiving the request for the regeneration process; preventing the regeneration process responsive to the time value being below the predetermined threshold; and setting the time value to a predetermined value responsive to the latch status being the second latch status.

In some embodiments, the user input is a first user input. In some embodiments, the instructions, when executed by the at least one processor, cause the at least one processor to perform further operations including: receiving the first user input at the operator interface device; and receiving, from the operator interface device, a first signal indicating that the latch status is the first latch status responsive to receiving the first user input at the operator interface device, wherein receiving the latch status is based on receiving the first signal.

In some embodiments, the instructions, when executed by the at least one processor, cause the at least one processor to perform further operations including: receiving a second user input at the operator interface device, subsequent to receiving the first user input and prior to the time value being at or above the predetermined threshold; and receiving, from the operator interface device, a second signal indicating that the latch status is the second latch status responsive to receiving the second user input at the operator interface device, wherein setting the time value to the predetermined value is responsive receiving the second signal.

In some embodiments, the instructions, when executed by the at least one processor, cause the at least one processor to perform further operations including: determining a power status associated with the engine based on receiving information indicative of the power status from at least one sensor associated with the engine, the engine power status including one of a first power status or a second power status; receiving, from the at least one memory device, the latch status responsive to the power status being the first power status; modifying the latch status to the second latch status responsive to the power status being the second power status; and setting the time value to the predetermined value responsive to the power status changing from the first power status to the second power status.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a schematic view of a block diagram of a vehicle system, according to an example embodiment.

FIG. 2 is a block diagram of the controller of FIG. 1, according to an example embodiment.

FIG. 3 is a flow diagram of a method of selectively enabling a regeneration process in the exhaust aftertreatment system of FIG. 1, according to an example embodiment.

### DETAILED DESCRIPTION

Following below are more detailed descriptions of various concepts related to, and implementations of methods, apparatuses, computer-readable media, and systems for selectively enabling regeneration of a component of an exhaust aftertreatment system. Before turning to the Figures, which illustrate certain exemplary embodiments in detail, it should be understood that the present disclosure is not limited to the details or methodology set forth in the description or illustrated in the Figures. It should also be understood that the terminology used herein is for the purpose of description only and should not be regarded as limiting.

As utilized herein, the term “operational data” and like terms are used to refer to data regarding the operation of a system or a component, such as an engine system or a component thereof. In some embodiments, operational data may include settings, values, or other information regarding the operation of a system. In some embodiments, the operational data may be measured (e.g., by one or more real sensors) and/or estimated or determined (e.g., by one or more virtual sensors or by a computer device or processing circuit).

As described herein, an engine system may include an engine and an exhaust aftertreatment system in exhaust gas receiving communication with the engine. The engine may be an internal combustion engine (ICE) configured to combust fuel. The exhaust aftertreatment system may include one or more components, such as a particulate filter configured to remove particulate matter, such as soot, from exhaust gas flowing in the exhaust gas conduit system, a dosing module (e.g., a doser) configured to supply a dosing fluid to the exhaust gas flowing in the exhaust gas system, and one or more catalyst devices configured to facilitate conversion of the exhaust gas constituents (e.g., nitrogen oxides, NOx) to less harmful elements (e.g., water, nitrogen), such as an oxidation catalyst, a selectively catalytic reduction (SCR) system, a three-way catalyst, and so on.

Over time, the particulate filter may accumulate particulate matter, reducing the effectiveness of the particulate filter (e.g., reducing the ability of the particulate filter to remove particulate matter from the exhaust gas). The control system may enable a “regeneration process” whereby a temperature of the exhaust gas (e.g., the exhaust gas temperature) increases to or above a predetermined threshold. When the exhaust gas temperature is at or above the predetermined threshold, at least a portion of the particulate matter accumulated on the particulate filter is burnt off, reducing the amount of particulate matter on the particulate filter. An active regeneration process occurs from specific commands intended to regenerate the aftertreatment system or a component thereof (e.g., commanding high power output, activation of an electric heater, commanding fuel to be provided to an oxidation catalyst upstream of the particulate filter such that the fuel is oxidized by the oxidation catalyst, etc.). For example, the active regeneration process is caused by a user input (via an operator I/O device) and/or is automatically commanded by the controller at various operating instances, such as during prolonged periods of idle (e.g., at a rest stop, etc.). A passive regeneration process may occur from operation of the system that results in elevated aftertreatment system temperatures (e.g., high load operating conditions that result in the generation of high exhaust gas temperatures that regenerate the component). In this way, an active regeneration is specifically commanded while a passive regeneration occurs without a specific input/command.

A control system or controller may facilitate the regeneration process by, for example, generating and providing the commands to implement the regeneration process (in this regard, an active regeneration process). An operator input/output device coupled to the controller may include at least one operator interface device, such as a button, a momentary switch, and so on. In this way, the operator interface device refers to the component and/or system that interfaces with an operator of the system 100. Responsive to receiving an input via the operator interface device, the controller may disable the active regeneration process (e.g., by preventing the commands from being generated and/or provided by a user via the operator interface device and/or automatically by the controller (e.g., without user input) to cause an active regeneration process). While the active regeneration process is disabled, the operation of the engine and/or the exhaust aftertreatment system does not change because, for example, the specific commands for changing the operation of the engine and/or the exhaust aftertreatment system are not generated or provided. However, the particulate filter may continue to accumulate particulate matter, degrading the performance of the particulate filter (e.g., increasing a pressure drop across the particulate filter, decreasing an amount of particulate matter removed from the exhaust gas per unit time or unit volume of the exhaust gas, etc.).

As described herein, the control system or controller may implement one or more controls to automatically reenable the active regeneration process. As described herein, the control system may, responsive to the deactivation of the active regeneration process, implement one or more controls to automatically reenable the active regeneration process after at least one predefined condition is met.

In one example, the control system may reenable the active regeneration process after a predetermined amount of time. For example, the control system may determine that a time value associated with the user input at the operator interface device is at or above a predefined threshold. That is, the control system may determine that the amount of time since the user input was received at the operator interface device (e.g., the “time value”) is at or above the predefined threshold. The control system may reset the time value responsive to receiving a second user input at the operator interface device. In this way, a subsequent user input (e.g., a third user input) at the operator interface device results in the active regeneration process being disabled, again. When the active regeneration process is disabled by the third user input, the regeneration process is disabled for a period of time that is at or below the predetermined amount of time.

In another example, the control system may reenable the active regeneration process responsive to receiving and/or determining a “power status” associated with the engine. In one embodiment, the “power status” includes one of a first power status or a second power status. The first power status is an “on” state of the engine where the engine is consuming fuel (e.g., idling, producing mechanical power, etc.). The second power status is an “off” state of the engine where the engine does not consume fuel. In some embodiments, the power status is received via a user input at a power device associated with the engine, such as a keyed ignition switch, a keyless ignition system, etc. For example, a user may insert a key into a keyed ignition switch and turn the key in a first direction to change the power status from the second power status (e.g., the off state) to the first power status (e.g., the on state). The user may then turn the key in a second direction to change the power status from the first power status (e.g., the on state) to the second power status (e.g., the off state). In some embodiments, the control system may receive the power status responsive to the power status changing from the first power status to the second power status. Advantageously, the control system may reset the time value responsive to receiving an indication that the power status changed from the first power status to the second power status, such that a subsequent user input at the operator interface device results in the regeneration process being disabled for up to the predetermined amount of time.

Technically and beneficially, the systems and methods described herein relate to automatically enabling a regeneration processes after a user (e.g., an operator of a vehicle) disables the regeneration processes. That is, the systems and methods described herein provide a technical solution to at least the technical problem of automatically (e.g., without user input) reenabling a regeneration processes after a user disables the regeneration process. In particular, the technical solution includes receiving, by a controller, a latch status associated with the operator interface device. The latch status is a first latch status (e.g., “on”) or a second latch status (e.g., “off”). When the latch status is the first latch status, the controller receives a time value associated with a user input responsive to the latch status being the first latch status. The controller can automatically modify the latch status to the second latch status responsive to the time value being at or above a predetermined threshold such that the regeneration process is enabled responsive to receiving the request for the regeneration process. Advantageously, reenabling the regeneration event may mitigate undesirable buildup of particulate matter (e.g., soot) within the aftertreatment system. That is, without automatically re-enabling the regeneration event, the regeneration event would not occur without user input (e.g., the second user input to set the latch status to the second latch status) and particulate matter may build-up which may lead to undesirable performance of the aftertreatment system and/or undesirable emissions characteristics (e.g., NOx amounts above a predefined threshold). These and other features and benefits are described more fully herein below.

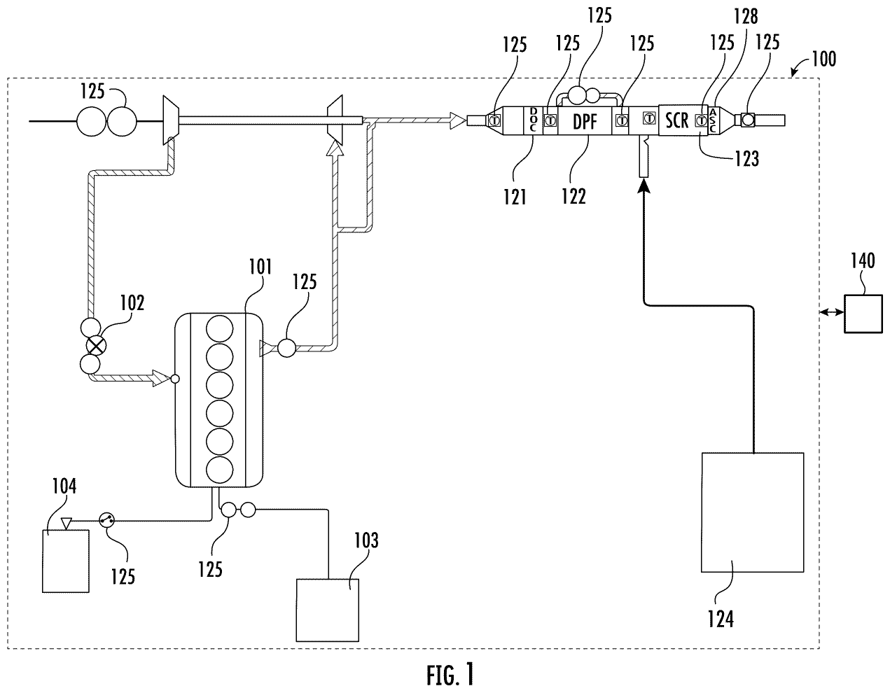

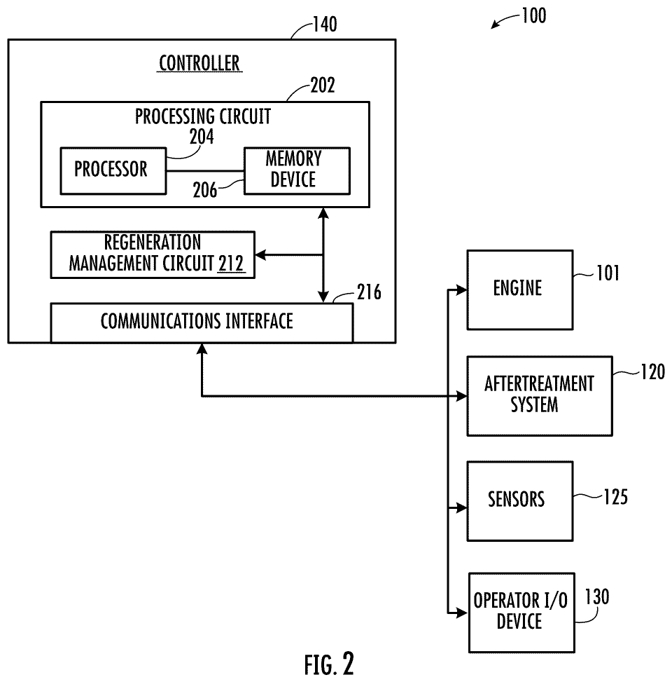

Now referring to FIG. 1, a schematic view of a block diagram of a vehicle system 100 is shown, according to an example embodiment. The system 100 includes an engine 101, an aftertreatment system 120 in exhaust gas receiving communication with the engine 101. The system 100 may also include a controller 140 (as shown in FIG. 2) and an operator input/output (I/O) device (also shown in FIG. 2), where the controller 140 is communicably coupled to each of the aforementioned components. In the configuration of FIG. 1, the system 100 is included in a vehicle. The vehicle may be any type of on-road or off-road vehicle including, but not limited to, wheel-loaders, fork-lift trucks, line-haul trucks, mid-range trucks (e.g., pick-up truck, etc.), sedans, coupes, tanks, airplanes, boats, and any other type of vehicle. In another embodiment, the system 100 may be embodied in a stationary piece of equipment, such as a power generator or genset. All such variations are intended to fall within the scope of the present disclosure.

The engine 101 may be any type of internal combustion engine that generates exhaust gas, such as a gasoline, natural gas, or diesel engine, and/or any other suitable engine. In the example depicted, the engine 101 is a part of a diesel engine system. In other embodiments, the engine 101 is part of a hybrid engine system having a combination of an internal combustion engine and at least one electric motor coupled to at least one battery. In some embodiments, the hybrid engine system may be configured as a mild-hybrid powertrain, a parallel hybrid powertrain, a series hybrid powertrain, or a series-parallel powertrain.

As shown in FIG. 1, an intake air throttle (IAT) valve 102, a fuel module 103, and an oil system 104 are coupled to the engine 101. The IAT valve 102 is structured to control an amount of air supplied to the engine 101. The fuel module 103 is structured to provide fuel to the engine 101 (e.g., from a fuel source). The fuel module 103 may control one or more fueling parameters including a fuel amount, a fuel pressure, a fuel injection timing, etc. The oil system 104 is configured to provide a lubricant (e.g., lubricant oil) to the engine 101.

The IAT valve 102 is a valve positioned at an air inlet of the engine 101. The IAT valve 102 may be actuated (e.g., by an actuator controlled by the controller 140) between an open position and a closed position. In the open position, the IAT valve 102 allows a maximum amount of air to flow from the air intake to the engine 101. In the closed position, the IAT valve 102 allows a minimum amount of air to flow from the air intake to the engine 101. The controller 140 may selectively actuate the IAT valve 102 (e.g., by controlling the actuator) in a plurality of positions between and/or including the open position and the closed position to adjust the amount of air received by the engine 101.

The aftertreatment system 120 is in exhaust-gas receiving communication with the engine 101. In the example depicted, the aftertreatment system includes a first catalyst member, shown as a diesel oxidation catalyst (DOC) 121, a filter (e.g., a particulate filter), shown as a diesel particulate filter (DPF) 122, and a second catalyst member, shown as a selective catalytic reduction (SCR) system 123. In some embodiments, the aftertreatment system 120 includes a third catalyst member, shown as an ammonia slip catalyst (ASC) 128. The DOC 121, the DPF 122, and the SCR 123 may be fluidly coupled by an exhaust gas conduit. The DOC 121 is structured to receive the exhaust gas from the engine 110 and to oxidize one or more exhaust gas constituents (e.g., hydrocarbons, carbon monoxide, etc.) in the exhaust gas. The DPF 122 is arranged or positioned downstream of the DOC 121 and structured to remove particulates or particulate matter, such as soot, from exhaust gas flowing in the exhaust gas stream. The DPF 122 includes an inlet, where the exhaust gas is received, and an outlet, where the exhaust gas exits after having particulate matter substantially filtered from the exhaust gas. In some implementations, the DPF 122 or other components may be omitted and/or other components added (e.g., a second SCR system having an additional dosing unit or module, multiple DOCs, etc.). Additionally, although a particular arrangement is shown for the aftertreatment system 120 in FIG. 1, the arrangement of components within the aftertreatment system 120 may be different in other embodiments (e.g., the DPF 122 positioned downstream of the SCR 123 and ASC).

The aftertreatment system 120 may further include a reductant delivery system which may include a decomposition chamber (e.g., decomposition reactor, reactor pipe, decomposition tube, reactor tube, etc.) to convert a reductant into ammonia, shown as a dosing module or unit 124. The reductant may be, for example, urea, diesel exhaust fluid (DEF), Adblue®, a urea water solution (UWS), an aqueous urea solution (e.g., AUS32, etc.), and other similar fluids. The dosing module 124 may include a reservoir, a pump, and a nozzle (and potentially other components or devices). The reservoir may be structured to store the reductant. The pump may be fluidly coupled to the reservoir and the nozzle by a dosing conduit and structured to pump the reductant from the reservoir to the nozzle. The nozzle may provide the reductant to the exhaust gas within the exhaust gas conduit. The reductant fluid is added to the exhaust gas stream to aid in the catalytic reduction. As shown in FIG. 1, the reductant may be injected upstream of the SCR 123 generally (or in particular, the SCR catalyst) by the dosing module 124 such that the SCR catalyst receives a mixture of the reductant and exhaust gas. The reductant droplets then undergo the processes of evaporation, thermolysis, and hydrolysis to form gaseous ammonia within the decomposition chamber, the SCR catalyst, and/or the exhaust gas conduit system, which leaves the aftertreatment system 120.

The DOC 121 is fluidly coupled to the exhaust gas conduit system to oxidize one or more gas constituents (e.g., hydrocarbons, carbon oxides, etc.) of the exhaust gas. In order to properly assist in the oxidation of the one or more gas constituents, the DOC 121 may be required to be at a certain operating temperature. In some embodiments, this certain operating temperature is approximately between 200-500° C. In other embodiments, the certain operating temperature is the temperature at which the conversion efficiency of the DOC 121 exceeds a predefined threshold (e.g., the conversion of hydrocarbons to less harmful compounds, which is known as the hydrocarbons conversion efficiency).

The SCR 123 is configured to assist in the reduction of NOx emissions by accelerating a NOx reduction process between the ammonia and the NOx of the exhaust gas into diatomic nitrogen (N2) and water (H2O). If the SCR catalyst is not at or above a certain temperature, the acceleration of the NOx reduction process is limited and the SCR 123 may not be operating at a level of a desired conversion efficiency (i.e., a value indicative of an amount of reduction of NOx emissions, also referred to as “deNOx efficiency”). In some embodiments, this certain temperature is approximately 200-600° C. The SCR catalyst may be made from a combination of an inactive material and an active catalyst, such that the inactive material (e.g. ceramic substrate) directs the exhaust gas towards the active catalyst, which is any sort of material suitable for catalytic reduction (e.g. metal exchanged zeolite (Fe or Cu/zeolite), base metals oxides like vanadium, molybdenum, tungsten, etc.).

When ammonia in the exhaust gas does not react with the SCR catalyst (either because the SCR 123 is below operating temperature or because the amount of dosed ammonia greatly exceeds the amount of NOR), the unreacted ammonia may bind to the SCR catalyst, becoming stored in the SCR 123. This stored ammonia is released from the SCR 123 as the SCR 123 warms, which can cause issues if the amount of ammonia released is greater than the amount of NOx passing through (i.e., more ammonia than needed for the amount of NOx, which can lead to ammonia slip). In some embodiments, the ASC 128 is included and structured to address ammonia slip by removing at least some excess ammonia from the treated exhaust gas before the treated exhaust gas is released into the atmosphere. As exhaust gas passes through the ASC 128, some of unreacted ammonia (i.e., unreacted with NOx) remaining in the exhaust gas is partially oxidized to NOx, which then consequently reacts with the remaining unreacted ammonia to form N2 gas and water. However, similar to the SCR catalyst, if the ASC 128 is not at or above a certain temperature, the acceleration of the NH3 reduction process is limited and the ASC 128 may not be operating at a level of efficiency to meet regulations or desired parameters. In some embodiments, this certain temperature is approximately 250-300° C.

As shown, a plurality of sensors 125 are included in the aftertreatment system 120. The number, placement, and type of sensors included in the aftertreatment system 120 is shown for example purposes only. That is, in other configurations, the number, placement, and type of sensors may differ. The sensors 125 may be gas constituent sensors (e.g., NOx sensors, oxygen sensors, etc.), temperature sensors, particulate matter (PM) sensors, flow rate sensors (e.g., mass flow rate sensors, volumetric flow rate sensors, etc.), other exhaust gas emissions constituents sensors, pressure sensors, some combination thereof, and so on. The gas constituent sensors may include an oxygen sensor that is structured to acquire data indicative of the presence of oxygen in the exhaust gas. The data from the oxygen sensor may be used to estimate an AFR value. The flow rate sensors may include a mass air flow (MAF) sensor structured to acquire data indicative of a mass flow rate of the exhaust gas. The temperature sensors are structured to acquire data indicative of a temperature value at each location that the temperature sensor is located.

The sensors 125 may be located in or proximate the engine 101, after the engine 101 and before the aftertreatment system 120, after the aftertreatment system 120, in the aftertreatment system as shown (e.g., coupled to the DPF and/or DOC, coupled to the SCR, etc.), upstream of the engine 101, etc. It should be understood that the location of the sensors may vary. In one embodiment, there may be sensors 125 located both before and after the aftertreatment system 120. In one embodiment, at least one of the sensors is structured as exhaust gas constituent sensors (e.g., CO, NOx, PM, SOx, etc. sensors). In another embodiment, at least one of the sensors 125 is structured as non-exhaust gas constituent sensors that are used to estimate exhaust gas emissions (e.g., temperature, flowrate, pressure, etc.). Additional sensors may be also included with the system 100. The sensors may include engine-related sensors (e.g., torque sensors, speed sensors, pressure sensors, flowrate sensors, temperature sensors, etc.). For example, in some embodiments, at least one of the sensors 125 is structured as an oil temperature sensor that is used to detect and/or determine an engine oil temperature. The sensors may further include sensors associated with other components of the vehicle (e.g., speed sensor of a turbo charger, fuel quantity and injection rate sensor, fuel rail pressure sensor, etc.).

The sensors 125 may be real or virtual (i.e., a non-physical sensor that is structured as program logic in the controller 140 that makes various estimations or determinations). For example, an engine speed sensor may be a real or virtual sensor arranged to measure or otherwise acquire data, values, or information indicative of a speed of the engine 101 (typically expressed in revolutions-per-minute). The sensor is coupled to the engine (when structured as a real sensor), and is structured to send a signal to the controller 140 indicative of the speed of the engine 101. When structured as a virtual sensor, at least one input may be used by the controller 140 in an algorithm, model, lookup table, etc. to determine or estimate a parameter of the engine (e.g., power output, etc.). Any of the sensors 125 described herein may be real or virtual.

The controller 140 is coupled and, particularly communicably coupled, to the sensors 125. Accordingly, the controller 140 is structured to receive data from one more of the sensors 125 and provide instructions/information to the one or more sensors 125. The controller 140 may use the received data to control one more components in the system 100 and/or for monitoring and thermal management purposes.

The operator input/output (I/O) device 130 may be coupled to the controller 140, such that information may be exchanged between the controller 140 and the I/O device 130, where the information may relate to one or more components of FIG. 1 or determinations (described below) of the controller 140. The operator I/O device 130 enables an operator of the system 100 to communicate with the controller 140 and one or more components of the system 100 of FIG. 1. For example, the operator input/output device may include, but is not limited to, an interactive display, a touchscreen device, one or more buttons and switches, voice command receivers, etc. In this way, the operator input/output device 130 may provide one or more indications or notifications to an operator, such as a malfunction indicator lamp (MIL), etc. Additionally, the vehicle may include a port that enables the controller 140 to connect or couple to a scan tool so that fault codes and other information regarding the vehicle may be obtained.

In some embodiments, the operator I/O device 130 includes an operator interface device. In some embodiments, the operator interface device is a button or a switch, such as a momentary switch. In other embodiments, the operator interface device is or is part of a graphical user interface provided on a display of the operator I/O device 130. For example, the operator interface device may be an interactable icon or similar element of a graphical user interface that a user can select via a touch input or with another device, such as a keyboard or mouse. In some embodiments, the operator I/O device 130 includes processing circuitry that enables communication between the operator interface device and the controller 140 (e.g., wired and wireless connections).

The controller 140 is structured to control, at least partly, the operation of the system 100 and associated sub-systems, such as the engine 101 and the operator I/O device 130. Communication between and among the components may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, etc. In one embodiment, a controller area network (CAN) bus provides the exchange of signals, information, and/or data. The CAN bus includes any number of wired and wireless connections. Because the controller 140 is communicably coupled to the systems and components of FIG. 1, the controller 140 is structured to receive data from one or more of the components shown in FIG. 1. The structure and function of the controller 140 is further described in regard to FIG. 2.

As the components of FIG. 1 are shown to be embodied in a vehicle, the controller 140 may be structured as one or more electronic control units (ECUs), such as one or more microcontrollers. The controller 140 may be separate from or included with at least one of a transmission control unit, an exhaust aftertreatment control unit, a powertrain control module, an engine control module, etc.

Now referring to FIG. 2, a schematic diagram of the controller 140 of the system 100 of FIG. 1 is shown, according to an example embodiment. As shown, the controller 140 includes at least one processing circuit 202 having at least one processor 204 and at least one memory device 206, a regeneration management circuit 212, and a communications interface 216. The controller 140 is structured to selectively enable and/or disable the regeneration process (e.g., the active regeneration process). As described herein, enabling the regeneration process allows for the regeneration process to occur when certain conditions are meet, such as an exhaust gas temperature value being at or above an exhaust gas temperature threshold, an aftertreatment system component temperature value being at or above a component temperature threshold, an engine speed value being at or above a speed threshold, and so on. Disabling the regeneration process prevents the regeneration process from occurring by, for example, preventing the operation of the engine 101 and/or the aftertreatment system 120 from being modified to achieve the above-described operating conditions, such as, preventing the exhaust gas temperature value from exceeding the exhaust gas temperature threshold, preventing the aftertreatment system component temperature value from exceeding the component temperature threshold, preventing the engine speed value from exceeding the speed threshold, and so on.

In one configuration, the regeneration management circuit 212 is embodied as machine or computer-readable media storing instructions that are executable by a processor, such as processor 204. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media instructions may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, regeneration management circuit 212 is embodied as one or more hardware units, such as one or more electronic control units. As such, regeneration management circuit 212 may be embodied as one or more circuitry components including, but not limited to, processing circuitry, network interfaces, peripheral devices, input devices, output devices, sensors, etc. In some embodiments, the regeneration management circuit 212 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, regeneration management circuit 212 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on. The regeneration management circuit 212 may also include or be programmable hardware devices such as field programmable gate arrays, programmable array logic, programmable logic devices or the like. The regeneration management circuit 212 may include one or more memory devices for storing instructions that are executable by the processor(s) of the regeneration management circuit 212. The one or more memory devices and processor(s) may have the same definition as provided below with respect to the memory device 206 and processor 204. In some hardware unit configurations, the regeneration management circuit 212 may be geographically dispersed throughout separate locations in the vehicle. Alternatively and as shown, the regeneration management circuit 212 may be embodied in or within a single unit/housing, which is shown as the controller 140.

In the example shown, the controller 140 includes the processing circuit 202 having the processor 204 and the memory device 206. The processing circuit 202 may be structured or configured to execute or implement the instructions, commands, and/or control processes described herein with respect to the regeneration management circuit 212. The depicted configuration represents the regeneration management circuit 212 being embodied as machine or computer-readable media storing instructions. However, as mentioned above, this illustration is not meant to be limiting as the present disclosure contemplates other embodiments where the regeneration management circuit 212 is configured as a hardware unit. All such combinations and variations are intended to fall within the scope of the present disclosure.

The processor 204 may be implemented as one or more single- or multi-chip processors, digital signal processors (DSPs), application specific integrated circuits (ASICs), field programmable gate arrays (FPGAs), and/or suitable processors (e.g., other programmable logic devices, discrete hardware components, etc. to perform the functions described herein). A processor may be a microprocessor, a group of processors, etc. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the regeneration management circuit 212 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 206 (e.g., memory, memory unit, storage device) may include one or more devices (e.g., RAM, ROM, Flash memory, hard disk storage) for storing data and/or computer code for completing or facilitating the various processes, layers and modules described in the present disclosure. For example, the memory device 206 may include dynamic random-access memory (DRAM). The memory device 206 may be communicably connected to the processor 204 to provide computer code or instructions to the processor 204 for executing at least some of the processes described herein. Moreover, the memory device 206 may be or include tangible, non-transient volatile memory or non-volatile memory. Accordingly, the memory device 206 may include database components, object code components, script components, or any other type of information structure for supporting the various activities and information structures described herein.

The communications interface 216 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle) and out-of-vehicle communications (e.g., with a remote server). For example, and regarding out-of-vehicle/system communications, the communications interface 216 may include an Ethernet card and port for sending and receiving data via an Ethernet-based communications network and/or a Wi-Fi transceiver for communicating via a wireless communications network.

The communications interface 216 may be structured to communicate via local area networks or wide area networks (e.g., the Internet) and may use a variety of communications protocols (e.g., IP, LON, Bluetooth, ZigBee, radio, cellular, near field communication).

In some embodiments, the controller 140 and/or one or more components thereof, such as the regeneration management circuit 212, is configured to facilitate the active regeneration process. For example, the controller 140 may generate one or more commands to increase a temperature of the exhaust gas (e.g., the exhaust gas temperature) to or above a predetermined threshold. When the exhaust gas temperature is at or above the predetermined threshold, at least a portion of the particulate matter accumulated on the DPF 122 is burnt off, reducing the amount of particulate matter on the DPF 122. In some embodiments, the one or more commands for facilitating the active regeneration process include causing the engine 101 (and particularly the fueling system), by the controller 140, to emit a predetermined amount of fuel into the aftertreatment system 120. The DOC 121 may facilitate oxidation of the fuel. The oxidation of the fuel is an exothermic reaction that increases the temperature of the exhaust gas. In some embodiments, the controller 140 may generate one or more commands to increase an engine speed of the engine 101. The increased engine speed may result in higher combustion temperatures and, therefore, higher exhaust gas temperatures. In some embodiments, the controller 140 may enable a cylinder deactivation mode, whereby one or more combustion cylinders of the engine 101 are deactivated. The remaining active cylinders of the engine 101 may consume a greater amount of fuel to keep up with a demanded amount of power output by the engine 101. The higher fuel consumption result in higher combustion temperatures and, therefore, higher exhaust gas temperatures. In some embodiments, the controller 140 may generate one or more commands to activate or increase the heat output by one or more heaters (e.g., electric heaters, ceramic heaters, etc.). In one example, the one or more heaters are configured to heat the exhaust gas (e.g., downstream of the engine 101 and upstream of the DPF 122), which may result in increased exhaust gas temperatures. In another example, the one or more heaters are configured to heat an intake air (e.g., upstream of the engine 101). The increased intake air temperature may result in higher combustion temperatures and, therefore, higher exhaust gas temperatures. In other embodiments, the one or more heaters may directly or indirectly heat up components of the system, such as of the aftertreatment system. The heated components may promote desired activity, such as catalytic activity of the SCR.

In some embodiments, the controller 140 and/or one or more components thereof, such as the regeneration management circuit 212, is configured to facilitate disabling the active regeneration process. For example, the controller 140 may receive a user input via the operator I/O device 130, or, more specifically, via the operator interface device. In some embodiments, when a user input is received at the operator interface device, the controller 140 is configured to disable the regeneration process. When the controller 140 disables the regeneration process, the controller 140 may prevent the one or more of the above-described commands, which represent a non-exhaustive list of regeneration commands, from being generated and implemented/executed. For example, the controller 140 may prevent one or more commands for increasing the temperature of the exhaust gas from being generated.

In various embodiments, the controller 140 and/or one or more components thereof, such as the regeneration management circuit 212, is configured to selectively enable or disable the active regeneration process. In some embodiments, the controller 140 may disable the regeneration process responsive to receiving a first user input at the operator interface device. The controller 140 may reenable the regeneration process responsive to receiving a second user input at the operator interface device. Advantageously, the controller 140 is also configured to reenable the regeneration process automatically (e.g., without user input) based on one or more predefined conditions. The processes for automatically reenabling the regeneration process are described in greater detail herein.

In an example embodiment, the controller 140 is configured to receive a request for the regeneration process. The regeneration process may be associated with a component of the aftertreatment system 120, such as the DPF 122.

The controller 140 is configured to receive and/or determine a latch status associated with a component of the operator I/O device 130, such as the operator interface device. The “latch” refers to a data element (e.g., a discrete piece of data or information). In some embodiments, the data element is a value, such as a binary value (e.g., 0 or 1). In other embodiments, the data element is a string (e.g., “on” or “off”, “true” or “false”) or other suitable data type. Thus, the “latch status” may be a value (which may be a numeric, alpha, and/or alpha-numeric value in the case of a string) indicative of a status of the latch. For example, when the latch is provided as a binary value, the “latch status” may be 0 or 1. In another example, when the latch is provided as a string, the latch status may be “on” or “off.” The latch status may be stored and updated in the memory 206 of the controller 140.

In some embodiments, the latch status is indicative of a state or recent state of the operator interface device. More specifically, the latch status can indicate whether a user manipulated (e.g., pressed, toggled, selected, etc.) the operator interface device. For example, before a user interacts with the operator interface device, the latch status is “0” or “off.” When a user interacts with the operator interface device, the latch status changes to “1” or “on” (when the latch status is structured as a binary representation). Subsequent interactions with the operator interface device cause the latch status to change between “0” and “1” or “on” and “off.” That is, the latch status changes (e.g., from “0” to “1” or from “1” to “0”) responsive to receiving a user input at the operator interface device. Alternatively, and as described below in greater detail, the controller 140 can automatically change the latch status.

In one embodiment, the latch status is received via the operator I/O device 103 and provided to the controller 140. The latch status may be retrievably stored by the memory device 206, and the controller 140 retrieves the latch status from the memory device 206. The latch status includes one of a first latch status or a second latch status.

The first latch status corresponds to an “on” state of the component of the operator interface device. The value of the latch that corresponds to the first latch status may be “1” or “on.” The latch status may be the first latch status when a first user input is received at the operator interface device. In an example embodiment, the first user input corresponds to a user activating the operator interface device to disable the active regeneration process. Thus, while the latch status is the first latch status, the controller 140 may disable the regeneration process.

The second latch status includes an “off” state of the component of the operator interface device. The value of the latch that corresponds to the second latch status may be “0” or “off.” The latch status may be the second latch status when a second user input is received at the operator interface device and/or when the controller 140 automatically sets the latch status to the second latch status. In an example embodiment, the second user input corresponds to a user deactivating the operator interface device to re-enable the active regeneration process. Additionally and/or alternatively, the controller 140 is configured to automatically set the latch status to the second latch status based on one or more predetermined conditions, which are described in greater detail herein below. Thus, while the latch status is the first latch status, the controller 140 may disable the regeneration process.

In an example embodiment, the controller 140 receives, retrieves, identifies, and/or otherwise determines the latch status responsive to receiving one of the first user input at the operator interface device or the second user input at the operator interface device. In another example embodiment, the controller 140 receives, identifies, retrieves, and/or determines the latch status responsive to receiving a different input, such as “power status.” The power status is described in greater detail herein below.

The controller 140 is configured to receive, identify, or determine a time value associated with the first user input. The time value is an amount of time between a current time value and a previous time value corresponding to the user input. In other words, the time value is an amount of time between a current time and a time when the first user input was received. The time value may be, for example, measured in minutes and seconds. That is, the time value may be less than one hour, less than two hours, etc. The time value may be measured via one or more computer-implemented time keeping devices, such as a clock, a stopwatch, a timer, etc., which, in some embodiments, is embodied by a virtual sensor 125. The time value may be stored by the memory device 206 of the controller 140. In one embodiment, the controller 140 may receive the time value responsive to the latch status being the first latch status.

The controller 140 is configured to modify the latch status from the first latch status to the second latch status responsive to the time value being at or above a predetermined threshold. The controller 140 is configured to prevent the active regeneration process responsive to the time value being below the predetermined threshold. The predetermined threshold may be a calibratable threshold. For example, the predetermined threshold may be set by a user, such as an operator of the system 100 or another user. The predetermined threshold may be, for example, greater than a minute. In particular, the predetermined threshold may be greater than a minute but less than an hour. For example, the predetermined threshold may be 30 minutes.

The controller 140 is configured to set the time value to a predetermined value responsive to the latch status being the second latch status. For example, the controller 140 may set the time value to the predetermined value responsive to modifying the latch status from the first latch status to the second latch status. In another example, the controller 140 may set the time value to the predetermined value responsive to receiving a second user input at the operator interface device 130, subsequent to receiving the first user input and prior to the time value being at or above the predetermined threshold. In yet another example, the controller 140 may set the time value to the predetermined value responsive to receiving a second signal indicating that the latch status is the second latch status responsive to receiving the second user input at the operator interface device 130. The predetermined value may be, for example, zero minutes.

In some embodiments, the controller 140 is configured to receive the power status associated with the engine 101. As described above, the power status includes one of a first power status or a second power status. In one embodiment, the controller 140 receives information indicative of the power status from one or more sensors 125. For example, the information indicative of the power status may include an engine speed value received from a speed sensor associated with the engine or an engine torque value received from a torque sensor associated with the engine. When the engine speed or the engine torque is zero, the controller 140 may determine that the power status is the second power status (e.g., the off state). When the engine speed or the engine torque is greater than zero, the controller 140 may determine that the power status is the first power status (e.g., the on state). In these embodiments, the controller 140 determines the power status based on receiving the information indicative of the power status.

In another embodiment, the information indicative of the power status is received from an ignition system (e.g., a keyed ignition, a button ignition, etc.). For example, when the ignition system is activated (e.g., keyed-on or otherwise activated), the controller 140 may determine that the power status is the first power status (e.g., the on state). When the ignition system is deactivated (e.g., keyed-off or otherwise deactivated), the controller 140 may determine that the power status is the second power status (e.g., the off state).

In some embodiments, controller 140 is configured to receive the latch status responsive to the power status being the first power status. For example, the controller 140 may receive the latch status when the system 100 is powered on. In some embodiments, the controller 140 is configured to modify the latch status to the second latch status responsive to the power status being the second power status. In some embodiments, the controller 140 is configured to modify the latch status to the second latch status responsive to the power status changing from the first power status to the second power status. For example, the controller 140 may set the latch status to the second latch status when the system 100 is powered off and/or when the system 100 changes from an on state to an off state.

In some embodiments, the controller 140 is configured to set the time value to the predetermined value responsive to the power status changing from the first power status to the second power status. For example, the controller 140 may set the time value to the predetermined value when the system 100 changes from an on state to an off state.

In some embodiments, the controller 140 is configured to receive an operating value regarding an operating condition of at least one of the aftertreatment system 120 or the engine 101, responsive to the latch status being the second latch status. For example, the controller 140 may receive one or more temperature values regarding the exhaust gas at or proximate the engine 101 or in the aftertreatment system 120. In another example, the controller 140 may receive an engine speed value or other value associated with the operation of the engine 101. In yet another example, the controller 140 may receive a component temperature regarding a component of the aftertreatment system 120.

In some embodiments, the controller 140 is configured to implement the active regeneration process responsive to the operating value being at or above the predetermined threshold. For example, when the one or more temperature values are at or above a predetermined temperature threshold, the controller 140 may implement the active regeneration process. In another example, when the engine speed value is at or above an engine speed threshold, the controller 140 may implement the active regeneration process. In yet another example, when the component temperature value is at or above a component temperature threshold, the controller 140 may implement the active regeneration process.

In some embodiments, the controller 140 is configured to prevent the active regeneration process responsive to the operating value being below the predetermined threshold. For example, when the one or more temperature values are below the predetermined temperature threshold, the controller 140 may prevent the active regeneration process. In another example, when the engine speed value is below the engine speed threshold, the controller 140 may prevent the active regeneration process. In yet another example, when the component temperature value is below the component temperature threshold, the controller 140 may prevent the active regeneration process.

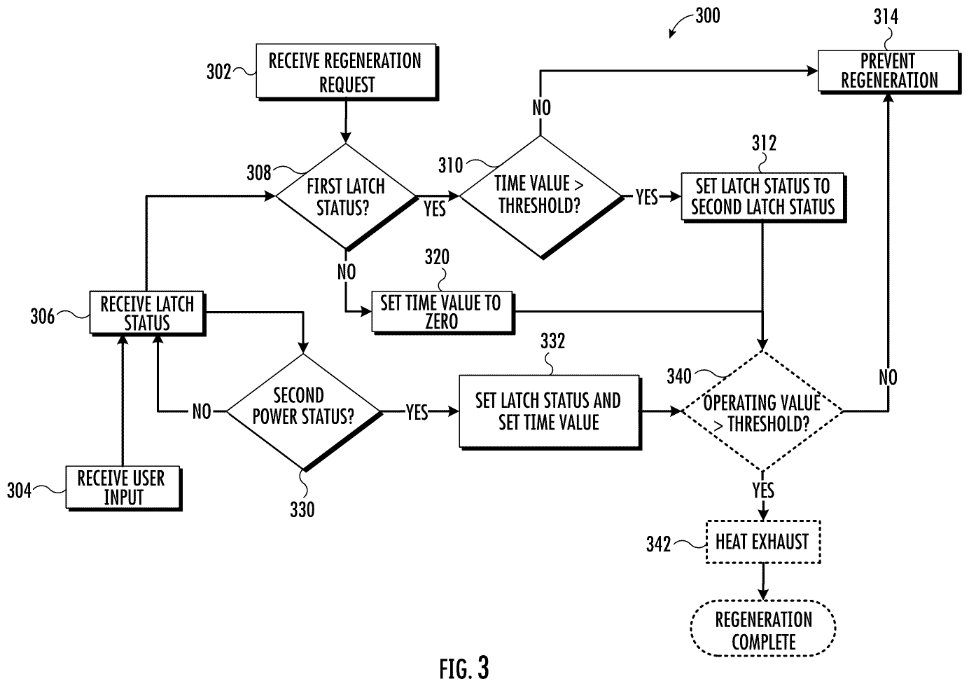

FIG. 3 is a flow diagram of a method 300 of selectively enabling a regeneration process, according to an example embodiment. In particular, the controller 140 and/or one or more components thereof, such as the regeneration management circuit 212, is structured to perform the method 300. In some embodiments one or more of the processes of the method 300 are optional. For example, process 340 and/or process 342 are optional and may be omitted from the method 300. In still other embodiments, one or more of processes may be combined with one or more other depicted process, and still further, additional processes may be added to the method 300 without departing from the spirit and scope of the present disclosure.

At process 302, the controller 140 receives or identifies a regeneration request. In some embodiments, the controller 140 may receive or identify the regeneration request responsive to, for example, a predefined time period since a most recent regeneration process (e.g., a most recent active regeneration process and/or a most recent passive regeneration process) elapsing. In some embodiments, the controller 140 may receive or identify the regeneration request responsive to a pressure change across one or more components of the aftertreatment system 120 (e.g., the DOC 121 or the DPF 122 being at or above a predefined threshold) or another indicator of an accumulation of particulate matter in the aftertreatment system (e.g., a sensed flow rate being at or below a predefined threshold). In this way, the controller 140 receives information indicative of the regeneration request from a sensor 125 (e.g., a pressure sensor, a flow rate sensor, or other suitable sensor) and identifies the regeneration request based on the operating data regarding the aftertreatment system (e.g., a pressure value, a flow rate value, etc.). In another embodiment, the controller 140 identifies the regeneration request based on receiving a user input (via the I/O device 130).

At process 304, the controller 140 receives a user input. The user input may be received at the operator interface device 130. In some embodiments, the user input is a first user input that sets the latch status to the first latch status. In some embodiments, the user input is a second user input that sets the latch status to the second latch status. The second user input may be received after the first user input.

At process 306, the controller 140 receives the latch status. As described herein, the latch status may be the first latch status or the second latch status. In some embodiments, the controller 140 receives the latch status responsive to receiving the user input at process 304. In some embodiments, the controller 140 receives the latch status responsive to receiving a power status and/or responsive to performing process 330. In some embodiments, the controller 140 receives, retrieves, or otherwise identifies and/or determines the latch status from the memory device 206. In other embodiments, the controller 140 receives the latch status from the operator I/O device 130, or, more specifically, the operator interface device (i.e., the operator I/O device 130 may store the latch status itself).

At process 308, the controller 140 identifies or determines (or receives an indication of from, for example, a sensor) whether the latch status is the first status. In some embodiments, the controller 140 may determine whether the latch status is the first latch status responsive to receiving the regeneration request at process 302. Responsive to the latch status being the first latch status, the controller 140 may proceed to process 310. Responsive to the latch status being the second latch status, the controller 140 may proceed to process 320.

At process 310, the controller 140 compares a time value to a predetermined threshold. In some embodiments, the controller 140 may receive the time value at process 310. For example, the controller 140 may receive the time value from the memory device 206 and/or a sensor 125. As described above, the predetermined threshold may be a calibratable threshold. In an example embodiment, the predetermined threshold is greater than a minute. In particular, the predetermined threshold may be greater than a minute but less than an hour. For example, the predetermined threshold may be 30 minutes. In other embodiments, the predetermined threshold may be more than 30 minutes or less than 30 minutes. Responsive to the time value being at or above the predetermined threshold, the controller 140 may proceed to process 312. Responsive to the time value being below the predetermined threshold, the controller 140 may proceed to process 314.

At process 312, the controller 140 sets the latch status to the second latch status. In particular, the controller 140 modifies the value (which may be an alpha-numeric value) of the latch stored at the memory device 206 to a value that corresponds with the second latch status, such as “0” or “off.” The controller 140 sets the latch status to the second latch status responsive to the time value being at or above the predetermined threshold. In some embodiments, after process 312, the controller 140 may proceed to process 340.

At process 314, the controller 140 disables or prevents the active regeneration process. In some embodiments, preventing or disabling the regeneration process includes preventing one or more commands from being generated. Typically, these commands correspond with increasing exhaust gas and/or aftertreatment system temperatures. For example, the one or more commands are prevented from being automatically generated responsive to, for example, determining or identifying one or more conditions that would otherwise trigger an active regeneration process. For example, a pressure value from a pressure sensor may indicate that the pressure drop across a particulate filter of the aftertreatment system 120 is at or below a threshold value, which would typically cause a regeneration process to be triggered when feasible (e.g., at the next idle or parked condition). As another example, operating data may indicate that the amount of time since the most recent regeneration process is at or above a predefined threshold. Typically, this would cause the controller 140 to generate one or more commands for an active regeneration process (e.g., activation of an aftertreatment system heater(s), increasing in engine power output, etc.) at a feasible time (e.g., at park or idle) to regenerate the component(s). However, the controller 140 may prevent these one or more commands. In other embodiments, preventing or disabling the regeneration process includes disabling a user input device that is used to start the active regeneration process. For example, the controller 140 may disable an icon on a touchscreen or prevent a physical button or switch from being activated. In still other embodiments, the controller 140 may disable one or more heaters, such that the heaters cannot heat the exhaust gas flowing to/through the aftertreatment system 120.

At process 320, the controller 140 may set the time value to a predetermined value. The controller 140 may set the time value to the predetermined value responsive to the latch status being the second latch status. In some embodiments, the predetermined value is zero. In some embodiments, after process 320, the controller 140 may proceed to process 340.

At process 330, the controller 140 determines whether the power status is the second power status. In some embodiments, the controller 140 may receive the power status at process 330. As described above, the first power status corresponds to an “on” state of the engine 101, and the second power status corresponds to an “off” state of the engine 101. In some embodiments, the controller 140 may perform process 330 after process 306 and responsive to the power status changing (e.g., from the first power status to the second power status or from the second power status to the first power status). Responsive to the power status being the first power status, the controller 140 may return to process 306. Responsive to the power status being the second power status, the controller 140 may proceed to process 332. In some embodiments, the controller 140 may proceed to process 332 responsive to the power status changing from the first power status to the second power status.

At process 332, the controller 140 sets the latch status to the second latch status and the time value to the predetermined value. For example, the controller 140 may set the latch status to the second latch status and set the time value to the predetermined value responsive to the power status being the second power status and/or responsive to the power status changing from the first power status to the second power status.

At process 340, the controller 140 determines, identifies, and/or receives an indication regarding whether one or more operating values are at or above a corresponding threshold. In some embodiments, the controller 140 may receive the one or more operating values at process 340. As described above, the one or more operating values may include one or more temperature values regarding the exhaust gas at or proximate the engine 101 or in the aftertreatment system 120, an engine speed value or other value associated with the operation of the engine 101, and/or a component temperature regarding a component of the aftertreatment system 120. Responsive to determining that the one or more operating values are at or above the corresponding thresholds, the controller 140 may proceed to process 342, where the controller 140 enables the regeneration process. Responsive to determining that the one or more operating values are below the corresponding thresholds, the controller 140 may proceed to process 314.

At process 342, the controller 140 generates and provides one or more commands to heat the exhaust gas emitted by the engine 101. The commands for heating the exhaust gas are described herein with respect to FIG. 2. The heated exhaust gas may cause particulate matter, such as soot, to burn off one or more components of the aftertreatment system 120, such as the DPF 122. Responsive to determining that the soot has been burnt off the DPF 122, the controller 140 may determine that the regeneration process is complete. The controller 140 may determine that the soot has been burnt off the DPF 122 based on, for example, a pressure change across the DPF 122 being at or below a predetermined value. For example, the controller 140 may receive a first pressure value regarding the exhaust gas upstream of the DPF 122 and a second pressure value regarding the exhaust gas downstream of the DPF 122. The controller 140 may compare a difference between the first pressure value and the second pressure value to a predetermined threshold. The controller 140 may determine that the soot has been burnt off the DPF 122 based on the pressure change across the DPF 122 being at or below the predetermined threshold.

Based on the foregoing, an example of operation may be described as follows. The controller 140 receives a regeneration request. The controller 140 receives a latch status responsive to receiving the regeneration request. If the latch status is the second latch status, the controller 140 enables the regeneration event. If the latch status is the first latch status (that is, a user has activated the operator interface device), the controller 140 disables the regeneration event and starts a timer. When the timer is at or above a threshold (e.g., 30 minutes), the controller 140 sets the latch status to the second latch status, thereby re-enabling the regeneration event. Advantageously, re-enabling the regeneration event may mitigate undesirable buildup of soot in or on the aftertreatment system, such as on the DPF 122. That is, without automatically re-enabling the regeneration event, the regeneration event would not occur without user input (e.g., the second user input to set the latch status to the second latch status).

Additionally, the controller 140 may optionally set the latch status to the second latch status, responsive to an engine off event. That is, the controller 140 re-enables the regeneration event after the engine off event. In this way, the regeneration event may occur after the engine off event, such as after a subsequent engine on event. Advantageously, re-enabling the regeneration event may mitigate undesirable buildup of soot on the DPF 122. That is, without automatically re-enabling the regeneration event after the engine off event, the regeneration event would not occur without user input (e.g., the second user input to set the latch status to the second latch status).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIG. 2, it should be understood that the controller 140 may include any number of circuits for completing the functions described herein. For example, the activities and functionalities of the regeneration management circuit 212 may be combined in multiple circuits or as a single circuit. Additional circuits with additional functionality may also be included. Further, the controller 140 may further control other activity beyond the scope of the present disclosure.

As mentioned above and in one configuration, the “circuits” may be implemented in machine-readable medium for execution by one or more of various types of processors, such as the processor 204 of FIG. 2. Executable code may, for instance, comprise one or more physical or logical blocks of computer instructions, which may, for instance, be organized as an object, procedure, or function. Nevertheless, the executables need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A system comprising:
a controller coupled to an aftertreatment system in exhaust gas receiving communication with an engine, the controller comprising at least one processor and at least one memory device storing instructions therein that, when executed by the at least one processor, cause the controller to perform operations comprising:
identifying a request for a regeneration process associated with a component of the aftertreatment system based on at least one of receiving an input at an operator input device or receiving, from one or more sensors, operating data regarding the aftertreatment system;
receiving, from the at least one memory device, a latch status associated with an operator interface device, the latch status comprising one of a first latch status or a second latch status;
receiving, from the at least one memory device, a time value associated with a user input responsive to the latch status being the first latch status;
modifying the latch status to the second latch status responsive to the time value being at or above a predetermined threshold such that the regeneration process is enabled responsive to receiving the request for the regeneration process;
preventing the regeneration process responsive to the time value being below the predetermined threshold; and
setting the time value to a predetermined value responsive to the latch status being the second latch status.

2. The system of claim 1, wherein the user input is a first user input, and wherein receiving the latch status associated with the operator interface device is responsive to:
receiving the first user input at the operator interface device; and
receiving, from the operator interface device, a first signal indicating that the latch status is the first latch status responsive to receiving the first user input at the operator interface device.

3. The system of claim 2, wherein setting the time value to the predetermined value responsive to the latch status being the second latch status is responsive to:
receiving a second user input at the operator interface device, subsequent to receiving the first user input and prior to the time value being at or above the predetermined threshold; and
receiving, from the operator interface device, a second signal indicating that the latch status is the second latch status responsive to receiving the second user input at the operator interface device.

4. The system of claim 1, wherein the instructions, when executed by the at least one processor, cause the controller to perform further operations comprising:
determining a power status associated with the engine based on receiving information indicative of the power status from at least one sensor associated with the engine, the power status comprising one of a first power status or a second power status;
receiving, from the at least one memory device, the latch status responsive to the power status being the first power status; and
modifying the latch status to the second latch status responsive to the power status being the second power status.

5. The system of claim 4, wherein the instructions, when executed by the at least one processor, cause the controller to perform further operations comprising setting the time value to the predetermined value responsive to the power status changing from the first power status to the second power status.

6. The system of claim 1, wherein the instructions, when executed by the at least one processor, cause the controller to perform further operations comprising:
receiving, from the one or more sensors, an operating value regarding an operating condition of at least one of the aftertreatment system or the engine, responsive to the latch status being the second latch status;
implementing the regeneration process responsive to the operating value being at or above the predetermined threshold; and
preventing the regeneration process responsive to the operating value being below the predetermined threshold.

7. The system of claim 1, wherein the time value is an amount of time between a current time value and a previous time value corresponding to the user input.

8. The system of claim 1, wherein the regeneration process is an active regeneration process.

9. The system of claim 1, wherein the predetermined value is zero.

10. A method comprising:
identifying a request for a regeneration process based on at least one of receiving an input at an operator interface device or receiving, from one or more sensors, operating data regarding the aftertreatment system;
receiving a latch status associated with the operator interface device, the latch status comprising one of a first latch status or a second latch status;
receiving a time value associated with a user input responsive to the latch status being the first latch status;
modifying the latch status to the second latch status responsive to the time value being at or above a predetermined threshold such that the regeneration process is enabled responsive to receiving the request for the regeneration process;
preventing the regeneration process responsive to the time value being below the predetermined threshold; and
setting the time value to a predetermined value responsive to the latch status being the second latch status.

11. The method of claim 10, wherein the user input is a first user input, and wherein the method further comprises:
receiving the first user input at the operator interface device; and
receiving, from the operator interface device, a first signal indicating that the latch status is the first latch status responsive to receiving the first user input at the operator interface device, wherein receiving the latch status is based on receiving the first signal.

12. The method of claim 11, further comprising:
receiving a second user input at the operator interface device, subsequent to receiving the first user input and prior to the time value being at or above the predetermined threshold; and
receiving, from the operator interface device, a second signal indicating that the latch status is the second latch status responsive to receiving the second user input at the operator interface device, wherein setting the time value to the predetermined value is responsive receiving the second signal.

13. The method of claim 10, further comprising:
determining a power status associated with an engine based on receiving information indicative of the power status from at least one sensor associated with the engine, the power status comprising one of a first power status or a second power status;
receiving, from the at least one memory device, the latch status responsive to the power status being the first power status; and
modifying the latch status to the second latch status responsive to the power status being the second power status.

14. The method of claim 13, further comprising setting the time value to the predetermined value responsive to the power status changing from the first power status to the second power status.

15. The method of claim 10, further comprising:
receiving, from the one or more sensors, an operating value regarding an operating condition of at least one of an aftertreatment system or an engine coupled to the aftertreatment system, responsive to the latch status being the second latch status;
implementing the regeneration process responsive to the operating value being at or above the predetermined threshold; and
preventing the regeneration process responsive to the operating value being below the predetermined threshold.

16. The method of claim 15, wherein the operating value comprises at least one of:
a component temperature value regarding a component of the aftertreatment system,
an exhaust gas temperature value regarding an exhaust gas emitted by the engine, or
a speed value regarding a speed of the engine.

17. An apparatus comprising:
at least one processor; and
at least one memory device storing instructions therein that, when executed by the at least one processor, cause the at least one processor to perform operations comprising:
identifying a request for a regeneration process based on at least one of receiving an input at an operator input device or receiving, from one or more sensors, operating data regarding the aftertreatment system;
receiving, from the at least one memory device, a latch status associated with an operator interface device, the latch status comprising one of a first latch status or a second latch status;
receiving, from the at least one memory device, a time value associated with a user input responsive to the latch status being the first latch status;
modifying the latch status to the second latch status responsive to the time value being at or above a predetermined threshold such that the regeneration process is enabled responsive to receiving the request for the regeneration process;
preventing the regeneration process responsive to the time value being below the predetermined threshold; and
setting the time value to a predetermined value responsive to the latch status being the second latch status.

18. The apparatus of claim 17, wherein the user input is a first user input, and wherein the instructions, when executed by the at least one processor, cause the at least one processor to perform further operations comprising:
receiving the first user input at the operator interface device; and
receiving, from the operator interface device, a first signal indicating that the latch status is the first latch status responsive to receiving the first user input at the operator interface device, wherein receiving the latch status is based on receiving the first signal.

19. The apparatus of claim 18, wherein the instructions, when executed by the at least one processor, cause the at least one processor to perform further operations comprising:
receiving a second user input at the operator interface device, subsequent to receiving the first user input and prior to the time value being at or above the predetermined threshold; and
receiving, from the operator interface device, a second signal indicating that the latch status is the second latch status responsive to receiving the second user input at the operator interface device, wherein setting the time value to the predetermined value is responsive receiving the second signal.

20. The apparatus of claim 17, wherein the instructions, when executed by the at least one processor, cause the at least one processor to perform further operations comprising:
determining a power status associated with an engine based on receiving information indicative of the power status from at least one sensor associated with the engine, the engine power status comprising one of a first power status or a second power status;
receiving, from the at least one memory device, the latch status responsive to the power status being the first power status;
modifying the latch status to the second latch status responsive to the power status being the second power status; and
setting the time value to the predetermined value responsive to the power status changing from the first power status to the second power status.
